(19) United States
(12) Patent Application Publication
(10) Pub. No.: US 2018/0170196 A1
(43) Pub. Date: Jun. 21, 2018

(54) CHARGING GUN WITH REPLACEABLE PLUG AND ASSEMBLY METHOD THEREOF

(71) Applicant: SUYING ELECTRCNICS (DONG GUAN) CO., LTD., Dongguan City (CN)

(72) Inventor: LI-YING HUANG, Dongguan City (CN)

(73) Assignee: SUYING ELECTRCNICS (DONG GUAN) CO., LTD., Dongguan City (CN)

(21) Appl. No.: 15/402,203

(22) Filed: Jan. 9, 2017

(30) Foreign Application Priority Data
Dec. 20, 2016 (CN) 201611185887.1

(51) Int. Cl. B60L 11/18; H02J 7/00

(52) U.S. Cl. CPC B60L 11/1818; B60L 2230/12; H02J 7/0045

(57) ABSTRACT

An assembly method of a charging gun with replaceable plug, a charging gun comprising a charging gun body and a plug disposed at an end of the charging gun body; wherein the plug includes a charging interface electrically connected with an external charging device to be charged; wherein the charging gun body is detachably connected to the plug, that is, when the plug is inserted into a connection port, the charging interface of the plug is connected to charging cables disposed inside the charging gun body through the connector, and a lock ring disposed on the charging gun body rotates a locking part which is interlocked with the lock ring to the lock position where a braking part disposed on the plug and corresponding to the locking part will interfere with the locking part, so that the plug cannot be removed from the connection port. Accordingly, the plug can be removed from the connection port and then replaced with a new plug without replacing the entire charging gun, the entire assembly and disassembly is very convenient.

### BACKGROUND OF THE INVENTION

### (1) Technical Field

The present invention relates to a charging technical field, particularly to a charging gun with replaceable plug and assembly method thereof for vehicle or hybrid vehicles.

### (2) Background Art

With the continuous improvement of people's awareness of energy conservation, and along with the progress of science and technology, electric vehicles and hybrid vehicles has been considerable development. The electric vehicles or hybrid vehicles can be driven by an electric motor, and the power source of the electric motor comes from a high-capacity storage battery disposed in the electric of hybrid vehicles, when the power is low, the battery needs to be charged.

At present, under the promotion of governments and enterprises, it has built a large number of electric car charging stations for the electric vehicle charging services. These charging stations basically charge the electric vehicle with the charging gun, but the existing charging gun is prone to aging and damage due to its insufficient. This problem arises mainly for the following reasons:

1. In order to shorten the charging time, the charging gun is used in high current charge, when the current is too large, the conductive contact parts of the plug would be prone to generate a lot of heat, so when the charging gun is used for a period of time, the plastic parts of the charging of the plug are prone to aging, damage, resulting in security risks, it must be replaced.

2. With the increasing popularity of electric vehicles, the frequency of the use of the charging gun is increased, the charging gun frequently being plugged and pulled with the charging socket of the electric car is easy to damage the plug part of the charging gun, so when the charging gun is used for a period of time, it must be replaced.

As described above, the plug of the charging gun which is engaged with the electric vehicle charging socket is easily damaged. However, since the plug and the charging gun are integrally provided or fixedly connected to the charging structure, when the plug is damaged, only the entire charging gun can be replaced, thus causing a great waste, the existing charging gun has been unable to meet market demand.

### BRIEF SUMMARY OF THE INVENTION

For solving the above-mentioned problems, the present invention provide a production method of double-wire string lights.

For achieving the purpose, the present invention adopts the following technical scheme: a charging gun with replaceable plug, comprising:

a charging gun body and a plug disposed at an end of the charging gun body; wherein the plug includes a charging port electrically connected with an external device to be charged; the charging gun body is detachably connected with the plug, wherein the charging gun body has a connection port to be engaged with the plug, and a lock ring is arranged outside the connection port; the plug is inserted into the connection port and locked at the connection port by the rotation of the locking ring, so that the plug cannot be disengaged from the connection port.

More preferably, wherein the charging gun comprises an annular groove disposed thereon and combined with the lock ring, and a bar-shaped hole disposed on the annular groove; the lock ring is disposed in the annular groove, and the inside of the lock ring is provided with a strip which is extended into the connection port through the bar-shaped hole; the strip is rotated along the sliding groove to the position of the gap by the rotation of the lock ring, and blocks the salient point to prevent the plug from being disengaged from the connection port.

More preferably, wherein the lock ring comprises an annular body, an arc-shaped strip disposed inside the annular body, and a connecting part configured to connect between the annular body and the arc-shaped strip; the annular body is sleeved on annular groove; the connecting part is passed through the bar-shaped hole of the annular groove; the strip is disposed inside the connecting port, and the rotational path of the strip being staggered with the position of the fastener on the plug.

More preferably, wherein the charging gun body comprises a connector; the connector is installed with a conductive socket corresponding to one end of the plug and configured to electrically connect with the charging cable disposed in the charging gun body; the plug comprises a charging pin extending rearwardly from the charging port; when the plug is inserted in the connection port, the charging port of the plug is connected with charging cables in the charging gun body through the connector.

More preferably, wherein the fastener is disposed on one side of the plug, extends in the direction of the connector, and outwardly formed with salient point disposed at rear ends of thereof; the connector comprises a sliding groove disposed around an outer surface thereof, and gaps arranged correspondingly to the fastener and passed through the sliding groove; when the plug is fully inserted into the connecting port, the fasteners passes through the sliding groove disposed on the connector, and the salient point is located just behind the sliding groove and does not interfere with the strip on the lock ring; the strip is rotated along the sliding groove to the position of the gap by the rotation of the lock ring, and blocks the salient point to prevent the plug from being disengaged from the connection port.

More preferably, wherein the connector comprises an annular sealing groove disposed around the outer surface thereof, and a sealing ring disposed in the annular sealing groove; the connector is sealed to an inner wall of the housing through the sealing groove.

More preferably, wherein the charging gun body comprises a housing and charging cables provided in the housing, the housing being formed with a connection port at a front end thereof, the charging cables extending from a rear end of the housing; the housing includes a switch button for controlling the charging cables.

More preferably, wherein the housing is composed of mutually cooperating right and left housings, and a sealing strip is provided on abutting surfaces of the left and right housings.

For solving the second technical problem, the present invention provides an assembly method of a charging gun with replaceable plug, a charging gun comprises a charging gun body and a plug disposed at an end of the charging gun body. Wherein the plug includes a charging port electrically connected with an external charging device to be charged; the charging gun body includes a connector disposed therein and configured to joint with the charging port of the plug; wherein the charging gun body is detachably assembled to the plug, that is, when the plug is inserted into a connection port, the charging port of the plug is connected to charging cables disposed inside the charging gun body through the connector, and a lock ring disposed on the charging gun body rotates a locking part which is interlocked with the lock ring to the lock position where a braking part disposed on the plug and corresponding to the locking part will interfere with the locking part, so that the plug cannot be removed from the connection port; when it is necessary to replace the plug, turn the lock ring in the reverse direction to separate the locking part from the brake part on the plug, so that the plug can be disengaged by the connection port.

Compared with the prior art, the invention has the following advantages: in the present invention, the charging gun body and the plug are detachably assembled. When the plug is damaged, it only needs to be removed from the charging gun and replaced with a new plug without replacing the entire charging gun. This will greatly reduce the cost of charging the gun and reduce waste. At the same time, the invention has the advantages of simple structure, convenient installation and disassembly.

### BRIEF DESCRIPTION OF THE SEVERAL VIEWS OF THE DRAWING(S)

FIG. 1 is a front view showing an assembled state of the present invention;

FIG. 2 is a perspective view showing the assembled state of the present invention;

FIG. 3 is a perspective view showing a state in which the charging gun body and the plug are separated from each other;

FIG. 4 is a perspective view of the internal structure of the present invention;

FIG. 5 is an exploded perspective view of the present invention;

FIG. 6 is a front view showing the charging gun body connected with the connector;

FIG. 7 is a perspective view showing the plug connected with connector and lock ring of the present invention;

FIG. 8 is a perspective view showing the plug connected with the lock ring of the present invention.

### DETAILED DESCRIPTION OF THE INVENTION

The embodiments of the invention is described in details with reference to the drawings hereinafter.

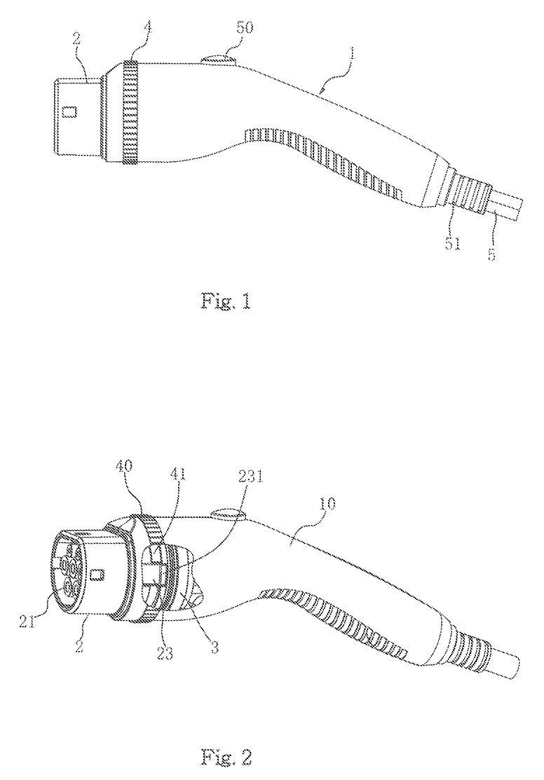

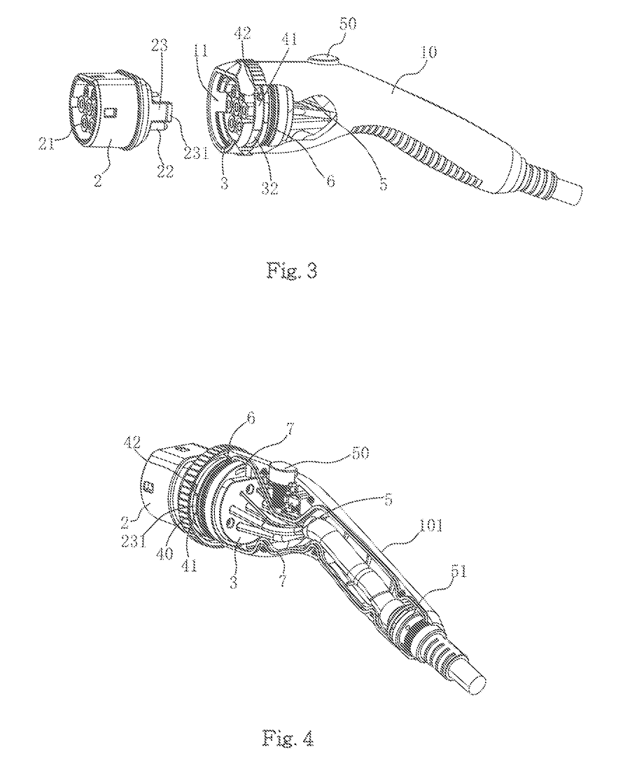

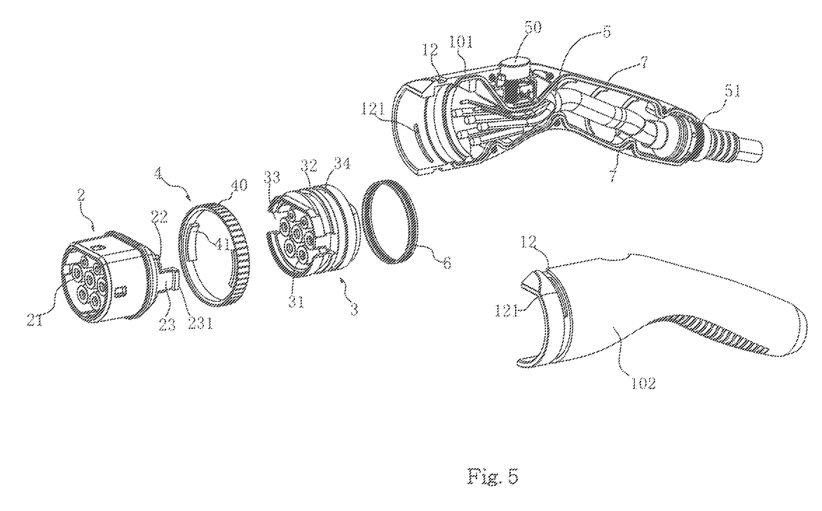

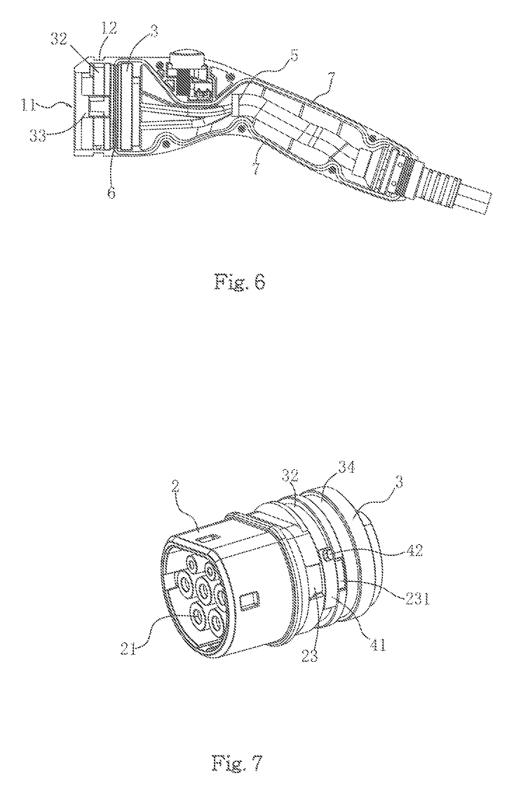

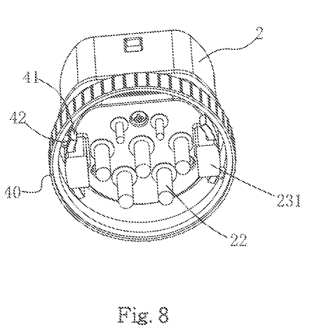

As illustrated in FIGS. 1-8, the assembly method of an embodiment of the present invention is as follows: a charging gun comprises a charging gun body (1) and a plug (2) disposed at an end of the charging gun body (1). The plug (2) includes a charging port (21) electrically connected with an external charging device to be charged; the charging gun body (1) includes a connector (3) disposed therein and configured to joint with the charging port (21) of the plug (2).

The charging gun body (1) is detachably assembled to the plug (2), comprising the following steps of:

inserting the plug (2) into a connection port (I 1), so that the charging port (21) of the plug (2) is connected to charging cables (5) disposed inside the charging gun body (1) through the connector (3);

rotating a lock ring (4) disposed on the charging gun body (1) to drive the rotation of a locking part to a locking position where a braking part disposed on the plug (2) and corresponding to the locking part will interfere with the locking part, so that the plug (2) cannot be removed from the connection port (11).

When it is necessary to replace the plug (2), turn the lock ring (4) in the reverse direction to separate the locking part from the brake part on the plug (2), so that the plug (2) can be disengaged by the connection port (11).

The specific structure of the embodiment is as follows:

The charging gun comprises a charging gun body (1), a plug (2) disposed at an end of the gun body (1), a connector (3) fixed in the charging gun body (1), and a locking ring (4) mounted on the charging gun body (1).

The charging gun body (1) comprises a housing (10) and charging cables (5) provided in the housing (10), the housing (10) being formed with a connection port (11) at a front end thereof, the charging cables (5) extending from a rear end of the housing (10); the housing 10 includes a switch button (50) for controlling the charging cables (5). The housing (10) is composed of mutually cooperating right and left housings (101, 102), and a sealing strip (7) is provided on abutting surfaces of the left and right housings (101, 102). The right and left housings (101, 102) can be fixed by screws, and the abutting surfaces thereof are sealed by the sealing strip (7). The housing (10) comprises a rubber block (51) at a through hole position of the rear end thereof for sealing and fixing the charging cables (5) extended therefrom.

The plug (2) has a shape corresponding to the shape of the connection port (11), and has a charging port (21) electrically connected to an external device to be charged, and a charging pin (22) extending rearwardly from the charging port (21). The charging port (21) is configured according to actual needs. Usually, the charging port includes at least a current output interface, a ground interface, a signal line, and the like. The plug (2) includes two fasteners (23) disposed on both sides thereof and extended in the direction of the connector (3), and two salient points (231) outwardly formed at rear ends of the fasteners (231).

The connector (3) is fixedly mounted in the connection port (11) of the charging gun body (1) and has a shape corresponding to the shape of the inside of the connection port (11) so as to be held in the connection port (11). The connector (3) is installed with a conductive socket (31) corresponding to one end of the plug (2) and configured to electrically connect with the charging cable (5) disposed in the charging gun body (1); when the plug (2) is inserted in the connection port (11), the charging port (21) of the plug (2) is connected to the conductive socket (31); the specific specification of the charging port and the conductive socket can be set up in accordance with the country, industry, or business-specific standard, there is no restriction in the embodiment.

Besides, the connector (3) comprises a sliding groove (32) disposed around an outer surface thereof, and gaps (33) arranged correspondingly to the fasteners (32) and passed through the sliding groove (32).

Moreover, the connector (3) comprises an annular sealing groove (34) disposed around the outer surface thereof, and a sealing ring (6) disposed in the annular sealing groove (34); the connector (3) is sealed to an inner wall of the housing (10) through the sealing groove (34). The sealing strip extends forwardly to the sealing ring (6) and extends rearwardly to the rubber block (51); the inside of the housing (10) of the charging gun body (1) is fully sealed by the sealing ring (6), the sealing strip (7), and the rubber block (51) for providing an effective waterproof function.

The lock ring (4) comprises an annular body (40), an arc-shaped strip (41) disposed inside the annular body (40), and a connecting part (42) configured to connect between the annular body (40) and the arc-shaped strip (41). The charging gun (1) comprises an annular groove (12) disposed thereon and engaged with the lock ring (4), and a bar-shaped hole (121) formed in the annular groove (12). The annular body (40) is sleeved on annular groove (12); the connecting part is passed through the bar-shaped hole (121) of the annular groove (12); the strip (41) is disposed inside the connecting port (11).

The plug (2) is inserted and installed in the connecting port (11), the shape of the plug (2) is corresponding to the shape of the connecting port (11), when the plug (2) is inserted into the connecting port (11), the fasteners (23) disposed on both sides of plug (2) will be inserted along the gaps (33) and jointed with the housing (10) of the charging gun body (1). Referring to FIG. 2, when the plug (2) is fully inserted into the connecting port (11), the fasteners (23) passes through the sliding groove (32) disposed on the connector (3), and the salient points (231) is located just behind the sliding groove (32) and does not interfere with the strip (41) on the lock ring (4); the strip (41) is rotated along the sliding groove (32) to the position of the gap (33) by the rotation of the lock ring (4), and blocks the salient point (231) to prevent the plug (2) from being disengaged from the connection port (11).

In this embodiment, if the plug (2) is damaged, it is only necessary to rotate the lock ring (4) in the reverse direction so that the strip (41) is staggered from the salient point (231), and the salient point (231) is unblocked. Accordingly, the plug (2) can be removed from the connection port (11) and then replaced with a new plug (2) without replacing the entire charging gun, the entire assembly and disassembly is very convenient.

The above only describes some exemplary embodiments of the present invention. Those having ordinary skills in the art may also make many modifications and improvements without departing from the conception of the invention, which shall all fall within the protection scope of the invention.

I claim:

1. A charging gun with replaceable plug, comprising:
a charging gun body and a plug disposed at an end of the charging gun body;
wherein the plug includes a charging port electrically connected with an external device to be charged; the charging gun body is detachably connected with the plug, that is, the charging gun body has a connection port to be engaged with the plug, and a lock ring is arranged outside the connection port; the plug is inserted into the connection port and locked at the connection port by the rotation of the locking ring, so that the plug cannot be disengaged from the connection port.

2. The charging gun with replaceable plug according to claim 1, wherein the charging gun comprises an annular groove disposed thereon and engaged with the lock ring, and a bar-shaped hole formed in the annular groove; the lock ring is sleeved in the annular groove and provided with a strip which is extended into the connection port through the bar-shaped hole; the plug is provided with fasteners which is engaged with insertion ends of the connection port; when the plug is inserted into the connection port and the lock ring is rotated, the strip moves with the rotation of the lock ring to the fasteners and interferes with the fasteners so that the plug can not be disengaged from the connection port.

3. The charging gun with replaceable plug according to claim 2, wherein the lock ring comprises an annular body, the arc-shaped strip disposed inside the annular body, and a connecting part configured to connect between the annular body and the strip; the annular body is sleeved on the annular groove of the charging gun body; the connecting part is passed through the bar-shaped hole of the annular groove; the strip is disposed inside the connecting port, and the rotational path of the strip being staggered with the position of the fastener on the plug.

4. The charging gun with replaceable plug according to claim 2, wherein the charging gun body comprises a connector; the connector is installed with a conductive socket corresponding to one end of the plug and configured to electrically connect with the charging cable disposed in the charging gun body; the plug comprises a charging pin extending rearwardly from the charging port and configured to connect to the conductive socket; when the plug is inserted in the connection port, the charging port of the plug is connected with charging cables in the charging gun body through the connector.

5. The charging gun with replaceable plug according to claim 4, wherein the fastener is disposed on one side of the plug, extends in the direction of the connector, and outwardly formed with salient point at a rear end of thereof; the connector comprises a sliding groove for the strip of the lock ring passing therethrough, and a gap arranged correspondingly to the fastener and passed through the sliding groove; when the plug is fully inserted into the connecting port, the strip is rotated along the sliding groove to the position of the gap by the rotation of the lock ring, and blocks the salient point to prevent the plug from being disengaged from the connection port.

6. The charging gun with replaceable plug according to claim 4, wherein the connector comprises an annular sealing groove disposed around the outer surface thereof, and a sealing ring disposed in the annular sealing groove; the sealing groove is configured to seal between the connector and an inner wall of a housing of the charging gun.

7. The charging gun with replaceable plug according to claim 6, wherein the charging gun body comprises the housing and charging cable provided in the housing, the housing being formed with a connection port at a front end thereof, and the charging cable extending from a rear end of the housing; the housing includes a switch button for controlling the charging cable.

8. The charging gun with replaceable plug according to claim 7, wherein the housing is composed of mutually cooperating right and left housings, and a sealing strip is provided on abutting surfaces of the left and right housings.

9. An assembly method of a charging gun with replaceable plug, the charging gun comprising:
a charging gun body and a plug disposed at an end of the charging gun body;
wherein the plug includes a charging port electrically connected with an external charging device to be charged; the charging gun body includes a connector disposed therein and configured to joint with the charging port of the plug;
wherein the charging gun body is detachably connected to the plug, comprising the following steps of:
inserting the plug into a connection port, so that the charging port of the plug is connected to charging cables disposed inside the charging gun body through the connector;
rotating a lock ring disposed on the charging gun body to drive the rotation of a locking part to a locking position where a braking part disposed on the plug and corresponding to the locking part will interfere with the locking part, so that the plug cannot be disengaged from the connection port;
when it is necessary to replace the plug, turn the lock ring in the reverse direction to separate the locking part from the braking part on the plug, so that the plug can be disengaged by the connection port.
